(19) United States
(12) Patent Application Publication
(10) Pub. No.: US 2021/0120840 A1
(43) Pub. Date: Apr. 29, 2021

(54) FORMULATION FOR THE PRODUCTION OF SUGAR-FREE SUGAR COTTON

(71) Applicant: Zukara SA de CV, Atizapán de Zaragoza (MX)

(72) Inventor: Julian Ernesto Real Angulo, Tultitlan Edo (MX)

(73) Assignee: Zukara SA de CV, Atizapán de Zaragoza (MX)

(21) Appl. No.: 17/133,507

(22) Filed: Dec. 23, 2020

Related U.S. Application Data
(63) Continuation-in-part of application No. 15/739,103, filed on Dec. 21, 2017.

(30) Foreign Application Priority Data
Aug. 5, 2016 (MX) 2016/010239

(51) Int. Cl. A23G 3/38; A23G 3/36; A23G 3/48; A23L 27/30

(52) U.S. Cl. CPC A23G 3/38; A23G 3/362; A23G 2200/14; A23L 27/36; A23G 3/48

(57) ABSTRACT

The present invention relates to the manufacturing industry of raw materials to produce sweet candies. More specifically, it is related to the manufacture of raw materials that normally comprise sucrose in its composition and more specifically to the manufacture of raw materials to produce cotton candy. The formulation has the advantage of not containing sucrose and allowing the manufacture of cotton candy; It can be processed in a normal cotton candy manufacturing machine and with a performance equal to that achieved when using sucrose; its components neither by digestion nor by metabolism, result in glucose. This formulation has the following qualitative base composition: Steviol Glycosides or Stevia rebaudiana Extract, Polydextrose, Isomaltose, Trehalose, Isomaltulose, Gluconodeltalactone, and Silicon dioxide.

### CROSS-REFERENCE TO RELATED APPLICATIONS

This application is a continuation-in-part of the U.S. patent application Ser. No. 15/739,103 filed on Dec. 21, 2017, which is a US national stage under 35 USC 371 of PCT/MX2017/000082 filed on Jul. 20, 2017, which claims priority to Mexican application no. 2016/010,239 filed on Aug. 5, 2016. The entire content of these applications is incorporated by reference herein.

### FIELD OF THE INVENTION

The present invention relates to the manufacturing industry of raw materials for the production of sweet candies. More specifically, it is related to the manufacture of raw materials that normally comprise sucrose in its composition and more specifically to the manufacture of raw materials for the production of cotton candy.

### BACKGROUND OF THE INVENTION

The normal or current powder mixtures with which the cotton candy is made contain only granulated sucrose and artificial colors. Sucrose contributes the total energy content to cotton candy; assuming that a portion of cotton candy contains 30 grams of sucrose, this portion provides 120 kcal. The high glycemic content of the resulting product limits its consumption in people with diabetes, hypertension or with cardiovascular diseases.

The vast majority of the artificial colors used in these products are related to the generation of cancer cells and the stimulation of certain allergy symptoms. A great advantage offered by this simple sucrose formula is its high flavor stability to the severe heat treatment to which the mixture is subjected in the cotton candy forming machine, as well as the high margin of malleability that the product has once it is melted so that it is sprayed and forms the cotton with enough volume to obtain a product with a very good appearance and stability; characteristics that were difficult to match with the sugar-free formulation sweetened with non-calorie sweeteners.

It is very obvious, when you are trying to substitute a sucrose in a composition, to think about the sweeteners as saccharin, aspartame and sucralose. Although also cyclamate and herbal sweetener stevia. However, in the case of a composition for the production of cotton candy, in which sucrose sugar, in addition to its sweetening and flavoring power, also confers the structure of the product, this change is not easy.

Cotton candy is produced by first melting the sucrose and by centrifugation, then forming a series of fine threads, passing the melted sugar through a series of tiny holes. These threads will form the cotton candy.

Some documents considered of the prior art, already describe the cotton candy manufacturing process, such documents are the following:

DE 102008037185 relates mainly to cotton candy made from isomaltulose. Various dyes, flavors and vitamins can be added to said composition. The manufacturing process consists of liquefying the isomaltulose to later heat it, thus achieving the formation of thin threads, which are cooled in a cooler environment and solidify until the cotton candy is formed.

KR 1020030056236 mentions a method of preparing a new type of sugar capable of achieving oral health, while having a sweet taste which is achieved by mixing isomaltose as the main ingredient with xylitol. This mixture is used in the manufacture of cotton candy, reducing stickiness.

US 2013/0236604 discloses a functional food, a candy floss is mentioned in the functional food options. The composition of the functional food comprising steviol rebaudiana extract, polydextrose and sugar is replaced with prebiotic polysaccharide polydextrose, a low intensity sweetener, isomalt, a high intensity sweetener, e.g. stevioside and/or Stevia rebaudiana extract. This document also disclose that the composition can be without sucrose.

As it can be evidenced from the previous documents, it is not easy to substitute sucrose for another sweetener, because this substitution of sweetener will hardly achieve the function of sucrose, which is to form the fibers that make up cotton. That is, neither saccharin, nor aspartame, nor sucralose, nor cyclamate and the herbal sweetener stevia, would have the behavior that allows sugar to form fibers (threads) and then the replacement of sucrose is complicated.

So a difficult paradigm to break is located here, because the substitution of sucrose would require finding a product that had the same behavior of sucrose both in its sweetening power, in its ability to melt at a given temperature, in its ability to form threads more or less resistant, in the caramel flavor that is generated when it melts, in its ability to store without weighing it down, etc.

With the awareness of the harmful effect of high intakes of digestible glucose, the need to replace sucrose or any other polysaccharide, disaccharide or monosaccharide has now been detected, with the ability to release glucose when digested in the digestive tract, such as starch, or transformed into glucose by metabolism, as in the case of fructose or galactose.

### OBJECTIVES OF THE INVENTION

One of the objectives of the present invention is to achieve a composition without sucrose that allows the manufacture of cotton candy.

Another objective is that said composition can be processed in a normal cotton candy manufacturing machine and with a performance equal to that achieved when sucrose is used.

Still another objective, in addition to replacing sucrose, is that the components that make up the composition, neither by digestion nor by metabolism, result in glucose.

Still another objective is to achieve a composition that does not absorb water or cake during storage after the manufacture of this raw material composition.

And all those advantages and objectives that will become evident with the reading of the present description accompanied by the examples that, as an integral part of said description, are attached for illustrative purposes but not limitation.

A technical problem that had to be solved during the selection of the components of the product formulation is that all commercial cotton machines operate at different cotton formation temperatures. All of them indicate that before starting to add the powder mixture, it must be allowed some time to work so that the product dispersion head reaches the maximum operating temperature. Each of these machines has an accessory (cup) with which the amount of powder mix to be added to the dispersing head of the machine is measured. Consequently, the cup has a size proportional to the size of the machine, which means that the mixture can operate in different cup sizes. Regardless of the maximum amount of product that can be added to the machine, the operating temperature of the machine must be sufficient to melt the powder mixture, and disperse it fluid enough to allow the formation of the threads that will shape the cotton.

### SUMMARY OF THE INVENTION

One of the first challenges we faced in obtaining a sugar-free composition, for the manufacture of cotton candy, was to find an edible compound with little assimilation of glucose when ingested, but with the ability to melt, without denaturing, so that with centrifugation they form threads and together they form the candy known as cotton candy.

Various food vehicles such as dextrose, polydextrose, malt dextrin, isomaltose, isomaltulose and inulin were tested. The only one that came out ahead, surprisingly, was poly dextrose, as the other vehicles were matted in the cotton thread-forming device, or the threads were matted once formed, by contacting each other, changing the cotton consistency.

This was somewhat surprising, because polydextrose was never thought to melt. Polydextrose is a substitute for sugar, starch and fat of low caloric value (approximately 1 kcal/g) and produces an effect similar to that of soluble dietary fibers, in addition to offering health benefits as a prebiotic. As a sugar substitute, polydextrose improves the texture and flavor of products, but it must be used in conjunction with other sweeteners, as they do not give a sweet taste.

Polydextrose also has a wide range of application in food products and can be used in bakery products, candies and chocolate, sweets in general, cereal bars, drinks, etc., but it has never been required to melt and form fibers. or threads for the manufacture of cotton candy.

Furthermore, polydextrose is a soluble fiber of 1 Kcal per gram and is obtained from the polymerization of glucose, sorbitol, and organic acid (for example, citric, fumaric, stearic, among others). It is highly branched, with all possible glycosidic bonds, and has a DP (Average Length) of 12. Polydextrose is not digested in the small intestine but is partially fermented in the large intestine. This results in various health benefits, including the growth of beneficial (prebiotic) bacteria, softening of the stool, less pH, production of short-chain fatty acids (which facilitate evacuation), attenuation of blood glucose and increased calcium absorption.

After testing the vehicles, the granulometry of the powder mix is in generally important for two reasons:

FIRST: A coarse or granular granulometry will allow the cotton candy manufacturing process to be carried out in such a way that the solids melt, spray and form the cotton candy threads, at such a rate that the structure of the cotton candy is formed with an adequate volume and characteristic of the product, in addition to good stability of the structure of the cotton candy once formed and high yields; otherwise, if the powder mixture is very fine, these results will not be obtained.

SECOND: There is a limit on the grain size of the mixture. If it is too thick, the powdered mixture will not be homogeneous, considering that there are other ingredients that will be part of the formulation such as flavors and natural powdered colorants that are added relatively in small proportions, but must be perfectly well dispersed throughout the mixture to obtain a consistent product always with good results; which it is not possible to do if the granulometry of the mixture is too thick, which causes a separation of these ingredients that are generally finer.

During the application of the polydextrose-based powder mixture, it detects that the product does not get to form effectively and adequately in the different commercial cotton machines. Therefore, it was necessary to reformulate the product in terms of the components that are integrated into the formulation, as well as the proportions to be added.

### DETAILED DESCRIPTION OF THE INVENTION

The qualitative composition for the manufacture of cotton candy without sucrose consists of the following components:

Steviol glycosides or Stevia rebaudiana extract.

### Polydextrose.

### Isomaltose.

### Isomaltulose.

### Trehalose.

### Gluconodeltalactone

Silicon dioxide

These components have the following function in the composition:

A. Steviol glycosides or Stevia Rebaudiana extract: It is the active ingredient that provides the main sweetness to the product, without the caloric contribution of sugar.

B. Polydextrose: It is the main vehicle or carrier in the formulation of the product. It has the function of a soluble fiber, helping in the absorption and digestion of the product.

C. Isomaltose: Its main function is to provide an acceptable grain size to the powder mixture to promote and regulate the crystallization of the ingredients during the process of formation of the sweet (cotton candy). Its calorie intake in the product is much lower than that of sucrose. Isomaltose is not an ingredient that provides fine, high-volume filaments for the formation of cotton candy. However, it is detected that the filaments that it forms have a high resistance to deformation. Therefore, it is concluded that this ingredient provides a base structure, or “skeleton”, on which the finest and fastest expanding filaments can be deposited and form the cotton candy.

D. Trehalosa: It provides thermodynamic characteristics to the mixture that make it functional to be applied in different types and sizes of cotton machines, regardless of the temperature and flow pattern of operation that it presents.

E. Isomaltulose: controls the crystallization of the mixture after melting and dispersing it in the cotton forming machine, and thus obtaining the characteristic fibers. This same similarity with sucrose allows cotton candy to provide satiety signals to the consumer's taste system. It provides the same calories as sucrose, but its glucose content is much lower.

F. Gluconodeltalactone: Helps to highlight the sweetness of the product without caloric intake; helps to preserve the cotton candy once it is formed.

G. Silicon dioxide has the function of preventing the humidification of poly dextrose since the latter is a highly hydrophilic compound.

The quantitative composition would be:

A. 0.3 to 0.5 weight % of Steviol glycosides or Stevia Rebaudiana extract.
B. 20 to 48 weight % of Polydextrose.
C. 5 to 20 weight of Trehalose.
D. 8 to 15 weight % of Isomaltose.
E. 3 to 10 weight % of Isomaltulose.
F. 0.8 to 1.20 weight % of Gluconodeltalactone.
G. 0.2 to 0.8 weight % of Silicon dioxide.

When leaving this quantitative composition:

The characteristic shape, appearance and texture of cotton candy will not be obtained.
The flavor of the product will not be sweet.
A product with an unacceptable excess bitter aftertaste is obtained.
A very remarkable beige or brown cotton candy is obtained, instead of a characteristic white cotton candy.
A cotton candy is obtained whose texture is not maintained or characteristically maintained long enough for consumption.
The product will not be functional for application in all commercial cotton machines.
The powdered product mix may over-agglomerate during storage for use, especially in wet locations.

Gluconodeltalactone helps to intensify Stevia's sweet flavor profile. With this, the bitter aftertaste that may occur due to the effect of Stevia is reduced or regulated.

By itself, polydextrose does not have the appropriate physical properties (melting and crystallization points) for obtaining cotton candy. Isomaltose helps polydextrose acquire these characteristics in the cotton machine at actual operating temperatures, thereby obtaining cotton candy with the desired appearance and texture characteristics.

To achieve the sucrose-free cotton candy composition of the present invention, the following tests had to be performed:

Sensory evaluation of different levels of Stevia addition to establish the most appropriate sweet flavor profile for the desired product. Application of the Hedonic scale for the evaluation of the samples obtained, and statistical analysis of the results.

Analysis of the melting point and crystallization temperature of different raw materials separately to select the most appropriate to form part of the mixture, according to the operating conditions of commercial cotton machines.

Tests of various formulations with different levels of use of the selected components, in the production of cotton candy in the cotton machine, in order to evaluate the characteristics of the product obtained.

Measurement of the operating temperature reached in different commercial cotton machines; and analyze the physical structure of each cotton machine in relation to the way of heating and flow pattern of the filaments formed.

Evaluate the main ingredients of the formulation separately in each of the cotton machines in order to identify their characteristics regarding the formation of cotton candy.

Based on the results of each of the tests described above, it was possible to fix the base formulation of the powder mixture of the present invention.

Likewise, it is necessary to indicate that the granulometry is important for the behavior of the mixture and of the manufactured cotton.

The granulometries of the different components that are part of the formulation of the powder mixture of the present invention, called Stevien, for cotton candy, are as follows:

From 0.2 to 0.5 mm of reabudioside, natural powder colors, natural powder flavorings and silicon dioxide.
From 0.71 to 0.8 mm of isomaltulose, trehalose, glucono deltalactone, citric acid, and ascorbic acid.
From 1.25 to 3.5 mm of polydextrose and isomaltose.

The granulometry of the powder mixture of the present invention, for the production of cotton candy, is mainly given by isomaltose, combined in precise proportions with isomaltulose and polydextrose, achieving a homogeneous powder mixture, free of caking during storage, and shelf life.

With this distribution of particle sizes, it is guaranteed that the formulation is functional for obtaining cotton candy in any cotton machine, with good characteristics of volume and stability of the cotton structure; that the mixing of the different ingredients that make up the product during the manufacturing process is homogeneous without significant phase separation; and that the powder mix does not weigh down during storage.

The proposal goes as well towards the development of a product for obtaining sweet cotton type of sugar candy. A sweetener proposal for application in the processing of low calorie processed foods are not always the same for all applications; because an important part is the role it plays in many physical and sensory characteristics of the finished product, not just in the sweetness.

A study of the physical properties of each of the possible ingredients that would be part of the final formulation of the product. To do this, a whole protocol of laboratory work had to be developed involving the list of ingredients as can be seen in the next examples, that are subjected physically to some of the next critic steps as melting temperature, crystallization and characteristics of the formed crystals; the ingredients selected of the formulation of this invention were selected for their physical properties, so they were tested to obtain the cotton candy formation, and observe their behavior and functionality to obtain the best cotton candy (e.g. good volume of cotton, acceptable structural resistance, pleasant feeling to the touch and palate, etc.). The protocol was developed to evaluate the behavior of the selected ingredients in 4 commercial cotton machines of different sizes, as it is desired that the Stevien powder mixing formulation for sweet cotton type of sugar be reliable so that sugar cotton can be obtained in any machine, from a domestic to an industrial one, because what is desired in the end is that the product is commercially feasible speaking.

Once the results of the evaluation of the ingredients have been obtained separately, and having assigned a numerical value to each of their properties to form cotton candy, a procedure is developed to obtain the ranges of specific proportions of each of the ingredients to obtain the best cotton candy in the 4 cotton machines with the lowest caloric load.

### EXAMPLES

### Example 1 Formulations to Avoid Weighing Down

The following were included as formulation ingredients: polydextrose, dextrose, Stevia and silicon dioxide; 4 formulations, specified in Table 1, were used, in which the levels of polydextrose and dextrose were modified, while the other two ingredients remained in the same amount in the 4 formulations, polydextrose being the most hygroscopic ingredient that will form part of the formulation. The four generated samples were packed in transparent low-density polyethylene bags, lined with kraft paper bags (simulating the packaging material to be used to package the product); and incubated at 42° C. with high relative humidity for 45 days.

CHART 1

| | Formu- | | Formu- | | Formu- | | Formu- | |
|---|---|---|---|---|---|---|---|---|
| Ingredient | lation1 | | lation2 | | lation3 | | lation4 | |
| Polidextrose | 10.00 | Kg | 20.00 | Kg | 30.00 | Kg | 40.00 | Kg |
| Dextrose | 40.00 | Kg | 30.00 | Kg | 20.00 | Kg | 10.00 | Kg |
| Stevia | 0.50 | g | 0.50 | g | 0.50 | g | 0.50 | g |
| Silicon dioxide | 0.05 | g | 0.05 | g | 0.05 | g | 0.05 | g |

At the end of the incubation time, the samples were reviewed and none of them presented product caking, therefore it is deduced that the levels of silicon dioxide used in each formulation are sufficient to avoid caking, regardless of the greater or lesser amount of polydextrose added; although it may also be that the granulometry of the added dextrose also contributes to dispersing the polydextrose enough to prevent it from caking over time.

As a preliminary result of this stage, the samples were tasted to know the degree of sweetness they present and a sweet flavor that was too intense and with an excessive degree of bitterness was found; which concludes that the level of Stevia added to each formulation is too much for the desired sweet flavor profile.

### Example 2 to Find the Best Degree of Sweetness

4 formulations were made with polydextrose, dextrose, Stevia and silicon dioxide, specified in Table 2, and applying different amounts of Stevia in each of the 4 formulations. With this test, the current amount of Stevia that is part of the current base formula was found, and with it is possible to obtain the degree of sweetness and sweet flavor profile of cotton candy.

In this same stage of experimentation, experimentation with 4 different formulas with different amounts of silicon dioxide is proposed, in order to find the minimum amount of this ingredient to be added in the formulation to avoid the caking of the powder mixture. The same amount of gluconodeltalactone was also added to each applied formulation; this to verify if this ingredient can improve the sweet flavor profile of the powdered mixture.

The four generated samples were packed in transparent low-density polyethylene bags, lined with kraft paper bags (simulating the packaging material to be used to package the product); and incubated at 42° C. with high relative humidity for 20 days.

CHART 2

| | Formu- | Formu- | Formu- | Formu- |
|---|---|---|---|---|
| Ingredient | lation 1 | lation 2 | lation 3 | lation 4 |
| Polidextrose | 10.00 Kg | 20.00 Kg | 30.00 Kg | 40.00 Kg |
| Dextrose | 40.00 Kg | 30.00 Kg | 20.00 Kg | 10.00 Kg |
| Stevia | 0.10 Kg | 0.20 Kg | 0.30 Kg | 0.40 Kg |
| Gluconodeltalactone | 0.10 Kg | 0.10 Kg | 0.10 Kg | 0.10 Kg |
| Silicon dioxide | 0.05 Kg | 0.10 Kg | 0.15 Kg | 0.20 Kg |

### Example 3 Test on the Cotton Machine

With the previous compositions the results were not very favorable since a very low cotton candy was obtained, not very bulky; and many residues and wastes were obtained. After several tests trying to form cotton candy with sucrose, polydextrose and dextrose separately, it was concluded that dextrose forms a too heavy liquid, which carries most of the solids to the bottom of the tray of the cotton machine., preventing them from dispersing with the cotton machine spray disk and forming a good amount of thread to form the cotton.

With the results obtained, an experimental protocol was proposed to evaluate the melting points and crystallization characteristics of different solids that could form part of the base formula of the Stevien powder mixture of the present invention.

### Example 4 Studies of Melting Points and Crystallization of Different Probable Components of the Formulation

The ingredients considered and evaluated are sucrose, dextrose, polydextrose, maltodextrin, isomaltose, trehalose and isomaltulose. The melting temperatures reached by each component individually, specified in Table 3, the crystallization point at the time of cooling, and the physical characteristics of the crystals obtained with each of the ingredients were noted. After the application of this experimental protocol, it follows that both dextrose and maltodextrin should not be part of the base formulation of the product, since their melting and crystallization characteristics are not in accordance with the process and conditions of formation of cotton candy.

CHART 3

| | | | Behavior of the |
|---|---|---|---|
| | Fusion | Crystallization | Melted and |
| Ingredient | temperature. | temperature | Crystallized Product |
| Dextrosa | 132° C. | 121° C. | When melting the |
| | | | product is quite fluid, it |
| | | | has almost no |
| | | | consistency or |
| | | | viscosity. Compared to |
| | | | the other ingredients, it |
| | | | takes a long time to |
| | | | crystallize. |
| Polydextrosa | 147° C. | 135° C. | The melted product has |
| | | | good consistency and |
| | | | viscosity. The |
| | | | crystallized product has |
| | | | a very brittle, brittle |
| | | | appearance. |
| Maltodextrina | N/a | N/a | The product is charred. |
| | | | It never melts. |
| | | | Therefore, its |
| | | | application for the |
| | | | development of the |
| | | | Invention is not |
| | | | feasible. |
| Isomaltosa | 154° C. | 142° C. | The melted product is |
| | | | very similar to that of |
| | | | sucrose, as are the |
| | | | characteristics once |
| | | | crystallized. |
| Trehalosa | 145° C. | 128° C. | Same results as |
| | | | Isomaltose, but at |
| | | | significantly different |
| | | | temperatures. |
| Isomaltulosa | 156° C. | 144° C. | Same results as |
| | | | Isomaltose. |

With the obtained results in this experimental stage, it is concluded that the ingredients that could form part of the base formula of the Stevien powder mixture for cotton candy of the present invention are: polydextrose, isomaltose, trehalose and isomaltulose, to which Stevia, gluconodeltalactone and silicon dioxide would be added at the levels of addition found in the previous experimental steps.

### Example 5 Behavioral Studies of the Main Ingredients of the Formulation Separately in Different Cotton Machines

Once the different cotton machines have been selected and characterized in terms of their operating conditions; The components: polydextrose, isomaltose, isomaltulose and trehalose are applied to each of them to characterize and define their behavior regarding the formation of cotton candy. Polydextrose and trehalose are found to be the best ingredients for cotton candy formation in terms of the volume of the final product obtained. Differences between these two ingredients are detected with respect to the stability of the filament structure, differences as significant as that the filaments formed by polydextrose are more brittle than those formed by trehalose, and that this brittle structure is more affected in the cotton machines where lower operating temperatures are reached.

Very particular properties of the ingredients are detected, which are important factors for the structure of the cotton formed, such as, although the cottons formed by trehalose and isomaltulose are very similar in terms of cotton volume, the filaments formed by isomaltulose are more sticky to the touch than those formed with trehalose, in all applied cotton machines; This discovery is very important, because a tacky texture to the touch will make the cotton structure collapse in less time, losing its volume very quickly to the detriment of its best appearance. With these tests, it is confirmed that isomaltose, even though it does not help to obtain an abundant quantity of filaments and therefore a good volume of cotton, the filaments formed are very resistant, and can function as a base structure or “skeleton” so that the rest of the filaments formed by the other ingredients form a more stable unit to the different properties they have (brittle structure, sticky structure, flexible structure, etc.).

### Example 6 Definition of the Final Composition

In the sixth part of the formulation, the amounts of appropriate ingredients are defined to obtain the cotton candy with the best sensory characteristics in terms of appearance, cotton volume, structure stability and caloric load per 20 gram serving. From the cotton formation studies evaluated in each of the main ingredients, in the 4 cotton machines of different sizes used, different qualifications are obtained. With these qualifications a range of quantity of each of the ingredients is obtained to form part of the formulation of the powder mixture, and that with it a cotton candy is obtained with the acceptable sensory characteristics, and with the lowest caloric load possible.

The proportions of the ingredients were tested by generating a sample of powder mixture, which was applied in the same quantity in the 4 cotton machines, and under the same temperature conditions. The results obtained in this sixth stage of experimentation conclude that the base composition for the Stevien powder blend for cotton candy is: polydextrose, isomaltose, trehalose, isomaltulose, Stevia, gluconodeltalactone and silicon dioxide.

With this formulation a cotton candy can be obtained that is bulky enough to cover the appearance requirements of the product; the degree of sweet taste of the product is excellent, with an acceptable sweet taste profile; without the need to include sucrose in the formulation, thereby reducing the caloric load of the final product, as well as a zero glycemic index. Even with this test it is detected that the inclusion of sucrose in the formulation causes a cotton candy less bulky, less firm to the touch and less stable to be obtained.

The invention has been sufficiently described so that a person with average knowledge in the matter can reproduce and obtain the results mentioned in the present invention. However, any person skilled in the field of the art that corresponds to the present invention may be able to make modifications not described in the present application, that for the application of these modifications in a certain composition or in the manufacturing process thereof, The subject matter claimed in the following claims is required, said structures must be included within the scope of the invention.

What is claimed is:

1. A formulation for the production of cotton candy without sucrose, comprising as a qualitative composition:
Steviol Glycosides or Stevia Rebaudiana Extract,
Polydextrose,
Isomaltose,
Trehalose,
Isomaltulose,
Glucono delta-lactone, and
Silicon dioxide.

2. The formulation to produce cotton candy without sucrose, according to claim 1, wherein the quantitative composition of the formulation is:
A. 0.3 to 0.5 weight % of Steviol glycosides or Stevia Rebaudiana extract,
B. 20 to 48 weight % of Polydextrose,
C. 5 to 20 weight of Trehalose,
D. 8 to 15 weight % of Isomaltose,
E. 3 to 10 weight % of Isomaltulose,
F. 0.8 to 1.20 weight % of Gluconodeltalactone,
G. 0.2 to 0.8 weight % of Silicon dioxide.

3. The formulation to produce cotton candy without sucrose, according to claim 1, wherein furthermore comprises citric acid and ascorbic acid.

4. The formulation to produce cotton candy without sucrose, according to claim 1, wherein the granulometry of each component is:
From 0.2 to 0.5 mm of reabudioside, natural powder colors, natural powder flavorings and silicon dioxide;
From 0.71 to 0.8 mm of isomaltulose, trehalose, glucono deltalactone, citric acid, and ascorbic acid; and
From 1.25 to 3.5 mm of polydextrose and isomaltose.

5. The formulation to produce cotton candy without sucrose, according to claim 3, wherein the granulometry of each component is:
From 0.2 to 0.5 mm of reabudioside, natural powder colors, natural powder flavorings and silicon dioxide;
From 0.71 to 0.8 mm of isomaltulose, trehalose, glucono deltalactone, citric acid, and ascorbic acid; and
From 1.25 to 3.5 mm of polydextrose and isomaltose.

6. The formulation to produce cotton candy without sucrose, according to claim 4, wherein the formulation has the same physical and sensory characteristics that the traditional cotton candy (make with sucrose).

7. The formulation to produce cotton candy without sucrose, according to claim 4, wherein the formulation has low calorie.

8. The formulation to produce cotton candy without sucrose, according to claim 5, wherein the formulation has the same physical and sensory characteristics that the traditional cotton candy (make with sucrose).

9. The formulation to produce cotton candy without sucrose, according to claim 5, wherein the formulation has low calorie.
